(19) United States
(12) Patent Application Publication
(10) Pub. No.: US 2018/0191736 A1
(43) Pub. Date: Jul. 5, 2018

(54) METHOD AND APPARATUS FOR COLLECTING CYBER INCIDENT INFORMATION

(71) Applicant: KOREA INTERNET & SECURITY AGENCY, Seoul (KR)

(72) Inventors: Hyei Sun Cho, Seoul (KR); Seul Gi Lee, Seoul (KR); Nak Hyun Kim, Seoul (KR); Byung Ik Kim, Seoul (KR); Tae Jin Lee, Seoul (KR)

(21) Appl. No.: 15/422,880

(22) Filed: Feb. 2, 2017

(30) Foreign Application Priority Data
Jan. 5, 2017 (KR) 10-2017-0001685
Jan. 20, 2017 (KR) 10-2017-0009978

(51) Int. Cl. H04L 29/06

(52) U.S. Cl. CPC H04L 63/14

(57) ABSTRACT

Provided are a method of collecting cyber incident information, the method being performed by an apparatus for collecting cyber incident information and comprises a first operation of collecting a cyber threat indicator through a first information sharing channel, a second operation of setting the collected cyber threat indicator as reference information and collecting an associated indicator retrieved from a second information sharing channel using the reference information, and a third operation of setting the associated. indicator as the reference information and repeating the second operation when it is determined that the associated indicator corresponds to the type of the reference information and that there is relevance between the cyber threat indicator and the associated indicator, wherein the second information sharing channel is determined according to the type of the reference information.

This application claims the benefit of Korean Patent Application Nos. 10-2017-0001685 filed on Jan. 5, 2017 and 10-2017-0009978 filed on Jan. 20, 2017, in the Korean Intellectual Property Office, the disclosure of which are incorporated herein by reference in their entirety.

### BACKGROUND

### 1. Field

The present inventive concept relates to a method and apparatus for collecting cyber incident information, and more particularly, to a method and apparatus for collecting cyber incident information related to a cyber attack in order to analyze a cyber incident caused by the cyber attack.

### 2. Description of the Related Art

A cyber incident due to a cyber attack refers to an act that causes damage, such as information leakage or service paralysis, using a malicious method such as hacking, virus, or malicious code infection. Cyber incidents due to cyber attacks are increasingly occurring in various forms, and the scale and extent of damage caused by the cyber incidents are increasing day by day. Therefore, there is an emphasized need for establishing preventive measures against the occurrence of cyber incidents due to cyber attacks.

Recent cyber incidents are characterized by continuous attacks that an attacker mounts by reusing attack IP, domain or malicious code after a certain period of time. If various information related to a recent cyber incident is collected and analyzed using such a characteristic of cyber incidents, it is possible to systematically predict future cyber incidents and respond promptly to the cyber incidents.

However, while there are various information sharing channels that provide cyber incident information, there is no system for integrating and collecting cyber incident information from the information providing channels. In addition, since the cyber incident information provided by the information sharing channels is very large, it is not easy to collect cyber information related to a specific cyber incident.

Therefore, there is a need for a method of systematically collecting cyber incident information related to a specific cyber incident based on various information sharing channels that provide cyber incident information.

### SUMMARY

Aspects of the inventive concept provide a method and apparatus for collecting relevant cyber incident information based on various information sharing channels that provide cyber incident information.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a method of collecting cyber incident information, the method being performed by an apparatus for collecting cyber incident information and comprises a first operation of collecting a cyber threat indicator through a first information sharing channel, a second operation of setting the collected cyber threat indicator as reference information and collecting an associated indicator retrieved from a second information sharing channel using the reference information, and a third operation of setting the associated indicator as the reference information and repeating the second operation when it is determined that the associated indicator corresponds to the type of the reference information and that there is relevance between the cyber threat indicator and the associated indicator, wherein the second information sharing channel is determined according to the type of the reference information.

According to another aspect of the inventive concept, there is provided an apparatus for collecting cyber incident information, the apparatus comprises one or more processors, a network interface which receives cyber incident information from at least one information sharing channel, a memory which loads a computer program to be executed by the processors; and a storage which stores the computer program and the received cyber incident information, wherein the computer program comprises a first operation of collecting a cyber threat indicator through a first information sharing channel, a second operation of setting the collected cyber threat indicator as reference information and collecting an associated indicator retrieved from a second information sharing channel using the reference information, and a third operation of setting the associated indicator as the reference information and repeating the second operation when it is determined that the associated indicator corresponds to the type of the reference information and that there is relevance between the cyber threat indicator and the associated indicator, wherein the second information sharing channel is determined according to the type of the reference information.

According to another aspect of the inventive concept, there is provided a computer program coupled to a computing device and stored in a recording medium to execute a first operation of collecting a cyber threat indicator through a first information sharing channel, a second operation of setting the collected cyber threat indicator as reference information and collecting an associated indicator retrieved from a second information sharing channel using the reference information, and a third operation of setting the associated indicator as the reference information and repeating the second operation when it is determined that the associated indicator corresponds to the type of the reference information and that there is relevance between the cyber threat indicator and the associated indicator, wherein the second information sharing channel is determined according to the type of the reference information.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the configuration of a system for collecting cyber incident information according to an embodiment;

FIG. 2 is a functional block diagram of an apparatus for collecting cyber incident information according to an embodiment;

FIG. 3 illustrates the hardware configuration of an apparatus for collecting cyber incident information according to an embodiment;

FIGS. 4A and 4B illustrate a method of collecting cyber incident information according to an embodiment;

FIGS. 5 and 6 illustrate a method of recursively collecting cyber incident information; and

FIGS. 7A through 11 illustrate various embodiments for improving the method of collecting cyber incident information.

### DETAILED DESCRIPTION

Hereinafter, embodiments of the inventive concept will be described in greater detail with reference to the attached drawings. Advantages and features of the present inventive concept and methods of accomplishing the same may be understood more readily by reference to the following detailed description of exemplary embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the invention to those skilled in the art, and the inventive concept will only be defined by the appended claims. Like reference numerals refer to like elements throughout the specification.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is for the purpose of describing particular embodiments only and is not intended to be limiting of the inventive concept. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

The definitions of the terms used in the present specification are as follows.

A cyber incident refers to an act that causes damage, such as information leakage or service paralysis, using a malicious method such as hacking, virus, or malicious code infection.

A cyber threat indicator refers to information about a IP, domain or malicious codes, e-mail, etc used in a cyber incident. For example, the cyber threat indicator may include information about a domain, an Internet protocol (IP), or malicious code used in a cyber incident.

An associated indicator refers to information associated with a cyber threat indicator For example, if the cyber threat indicator is a domain, the associated indicator may be similar domain information based on a top-level domain (TLD)/a second-level domain (SLD). The associated indicator may vary according to the type of the cyber threat indicator, and detailed examples of the associated indicator will be described later.

An information sharing channel refers to an information channel that provides a cyber threat indicator or an associated indicator. Examples of the information sharing channel may include a domain name server (DNS) that provides domain information and a malicious code information sharing site (e.g., virusshare.com). Detailed examples of the information sharing channel will be described later.

Cyber incident information is a concept that includes all information associated with a cyber incident. That is, the cyber incident information includes cyber threat indicators and associated indicators and can be understood as a wider concept encompassing not only information collected through information sharing channels but also information created or processed based on the collected information. In the related technical field, a term ‘cyber incident information’ can be used with a term ‘cyber observable’ interchangeably.

Hereinafter, the inventive concept will be described in more detail with reference to the accompanying drawings.

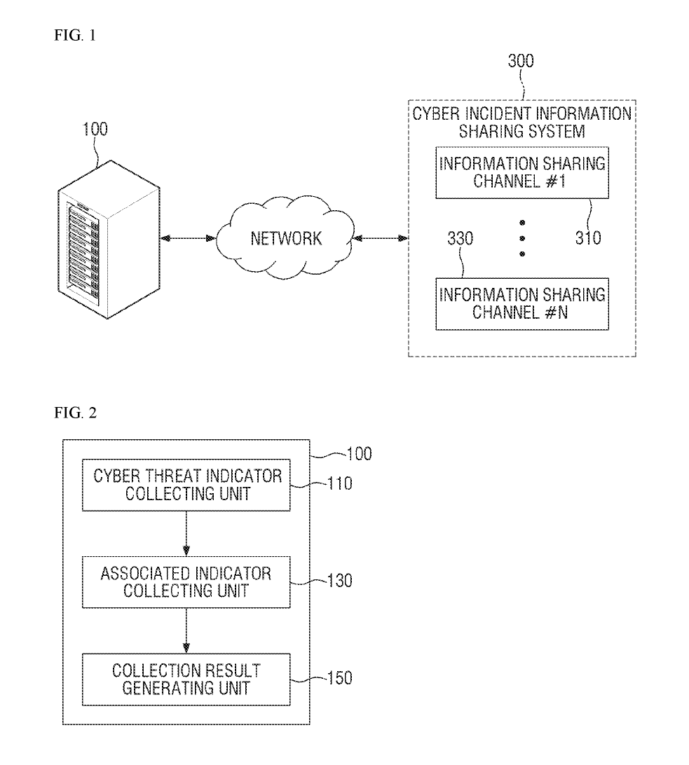

FIG. 1 illustrates the configuration of a system for collecting cyber incident information according to an embodiment.

Referring to FIG. 1, the cyber incident information collecting system is a system for integrating and collecting various types of cyber incident information in order to analyze a cyber incident caused by a cyber attack. As described above, the cyber incident information includes cyber threat indicators and associated indicators relevant to the cyber threat indicators.

The cyber incident information collecting system may include an apparatus 100 for collecting cyber incident information and a system 300 for sharing cyber incident information. However, this is merely an embodiment for achieving the objectives of the inventive concept, and some components can be added or removed if necessary.

The cyber incident information collecting apparatus 100 is a computing device that collects cyber threat indicators in real time or in non-real time through various information sharing channels 310 through 330 provided by the cyber incident information sharing system 300 and recursively collects associated indicators relevant to the cyber threat indicators. The computing device may be a notebook computer, a desktop computer, a laptop computer, or the like. However, the computing device is not limited to these examples and can be any kind of device having a computing function and a communication function.

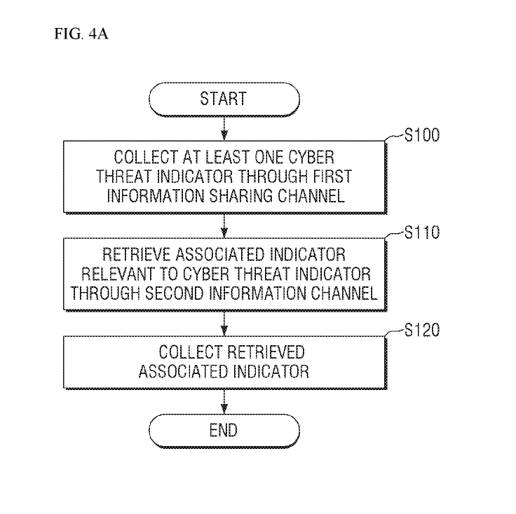

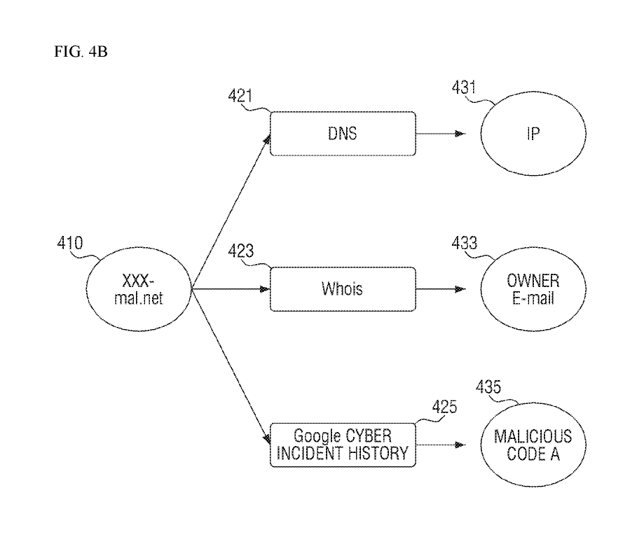

The cyber incident information collecting apparatus 100 may include a database (DB) storage device for storing collected cyber incident information. A method by which the cyber incident information collecting apparatus 100 recursively collects cyber incident information will be described in detail later with reference to FIGS. 4 through 11.

The cyber incident information sharing system 300 is a system for providing various types of cyber incident information. The cyber incident information sharing system 300 may include a plurality of information sharing channels 310 through 330 that provide cyber incident information. For example, the information sharing channels 310 through 330 may include a cyber black box, C-share (a cyber incident information sharing system operated by the Korea Internet & Security Agency), a domain name server-based blacklist (DNSBL), and a distributing point/a. malicious code sharing site such as virusshare.com. However, the information sharing channels 310 through 330 can also include all kinds of data sources that provide cyber incident information.

The cyber incident information collecting apparatus 100 and the cyber incident information sharing system 300 may be connected to each other through a network. Here, the network may be implemented as any kind of wired/wireless network such as a local area network (LAN), a wide area network (WAN), a mobile radio communication network, or a wireless broadband Internet (Wibro).

In FIG. 1, the cyber incident information collecting apparatus 100 collects cyber incident information from the external cyber incident information sharing system 300 through the network. However, according to an embodiment, the cyber incident information collecting apparatus 100 may also he configured to include some information sharing channels. In this case, the cyber incident information collecting apparatus 100 may collect some cyber incident information from the internal information sharing channels and collect some other cyber incident information from external information sharing channels provided by the cyber incident information sharing system 300.

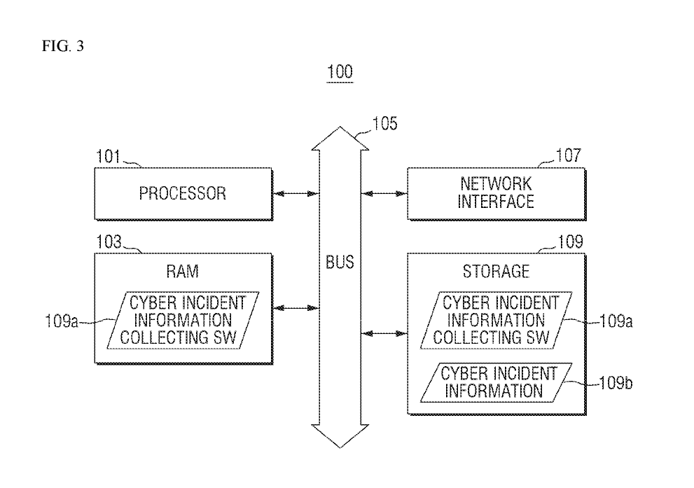

Until now, the cyber incident information collecting system according to the embodiment has been described with reference to FIG. 1. The configuration and operation of the cyber incident information collecting apparatus 100 will now be described with reference to FIGS. 2 and 3.

FIG. 2 is a functional block diagram of an apparatus 100 for collecting cyber incident information according to an embodiment.

Referring to FIG. 2, the cyber incident information collecting apparatus 100 may include a cyber threat indicator collecting unit 110, an associated indicator collecting unit 130, and a collection result generating unit 150. In FIG. 2, components only related to the current embodiment are illustrated. Therefore, it will be understood by those of ordinary skill in the art to which the inventive concept pertains that other general-purpose components can be included in addition to the components illustrated in FIG. 2.

Specifically, the cyber threat indicator collecting unit 110 collects one or more cyber threat indicators in real time or in non-real time from an information sharing channel (hereinafter, referred to as a ‘first information sharing channel’) which provides information about cyber threat indicators used in cyber incidents. Here, the first information sharing channel may be, for example, a cyber black box or C-share (a cyber incident information sharing system operated by the Korea Internet & Security Agency). The first information sharing channel will be described in detail later. In addition, the cyber threat indicators may include IP information, domain information, and hash information of malicious code used in a cyber attack.

The associated indicator collecting unit 130 queries information sharing channels (hereinafter, referred to as ‘second information sharing channels’), which provide cyber incident information associated with cyber threat indicators, using a collected cyber threat indicator as reference information and collects retrieved associated indicators. Here, the reference information refers to information used to retrieve the associated indicators from the second information sharing channels.

For reference, at least some of the second information sharing channels queried may be set to different kinds of information sharing channels according to the type of the reference information. For example, if the type of the reference information is IP information, the second information sharing channels may be IP2Location and DNS which provide information associated with the IP information. The second information sharing channels will be described in detail later.

If the type of a first associated indicator collected corresponds to IP information, domain information or malicious code information, the associated indicator collecting unit 130 may recursively query the second information sharing channels by setting the first associated indicator as the reference information and collect a second associated indicator relevant to the first associated indicator. This collecting process may be repeated. That is, if a collected associated indicator corresponds to a preset type, the associated indicator collecting unit 130 may repeat the process of recursively collecting associated indicators. A method by which the associated indicator collecting unit 130 recursively collects associated indicators will be described in detail later with reference to FIGS. 4 through 11.

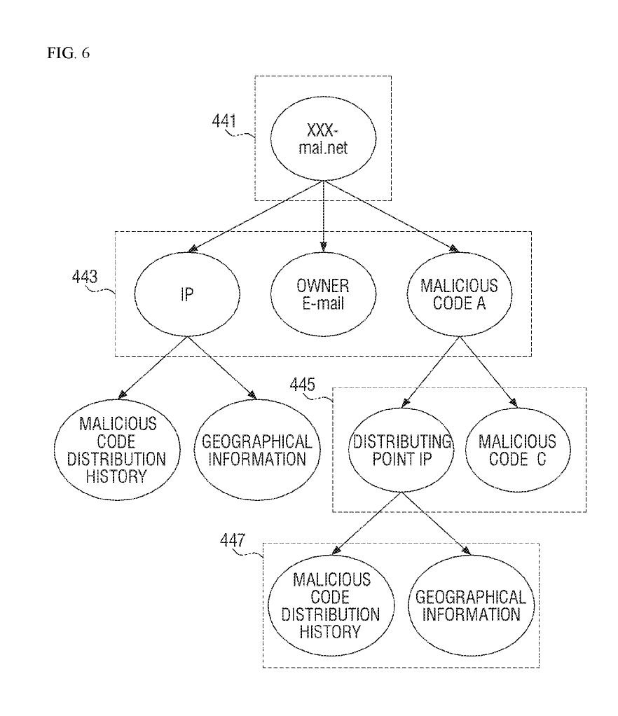

Lastly, the collection result generating unit 150 generates and provides collected cyber incident information in various formats. For example, the collection result generating unit 150 may generate and provide an association graph showing the association between pieces of collected cyber incident information. Specifically, the collection result generating unit 150 may present the collection result in the form of an association graph as illustrated in FIG. 6 by creating nodes indicating a collected cyber threat indicator and a collected associated indicator and creating an edge indicating the association between the two indicators. For reference, since associated indicators are recursively collected, the association graph may take a hierarchical form. Of nodes connected by an edge, a node of an upper layer may represent reference information, and a node of a lower layer may represent an associated indicator retrieved from a second information sharing channel using the reference information.

Each component of FIG. 2 may be, but is not limited to, a software component or a hardware component such as a Field Programmable Gate Array (FPGA) or Application Specific Integrated Circuit (ASIC). The components may be configured to reside on a computer-readable storage medium and configured to execute on one or more processors. The functionality provided for in the components may be further separated into additional components or may be combined into fewer components.

FIG. 3 illustrates the hardware configuration of an apparatus 100 for collecting cyber incident information according to an embodiment.

Referring to FIG. 3, the cyber incident information collecting apparatus 100 includes one or more processors 101, a bus 105, a network interface 107, a memory 103 which loads a computer program to be executed by the processors 101, and a storage 109 which stores cyber incident information collecting software 109a. In FIG. 3, components only related to the current embodiment are illustrated. Therefore, it will be understood by those of ordinary skill in the art to which the inventive concept pertains that other general-purpose components can be included in addition to the components illustrated in FIG. 3.

The processors 101 control the overall operation of each component of the cyber incident information collecting apparatus 100. The processors 101 may include a central processing unit (CPU), a micro-processor unit (MPU), a micro-controller unit (MCU), or any form of processor well known in the art to which the inventive concept pertains. In addition, the processors 101 may perform an operation on at least one application or program for executing methods according to embodiments. The cyber incident information collecting apparatus 100 may include one or more processors.

The memory 103 stores various data, commands and/or information. The memory 130 may load one or more programs 109a from the storage 100 to execute methods of collecting cyber incident information according to embodiments. In FIG. 6, a random access memory (RAM) is illustrated as an example of the memory 103.

The bus 105 provides a communication function between the components of the cyber incident information collecting apparatus 100. The bus 105 may be implemented as various forms of buses such as an address bus, a data bus and a control bus.

The network interface 107 supports wired and wireless Internet communication of the cyber incident information collecting apparatus 100. In addition, the network interface 107 may support various communication methods as well as Internet communication. To this end, the network interface 107 may include various communication modules well known in the art to which the inventive concept pertains.

The network interface 170 may receive cyber incident information from various information sharing channels included in the cyber incident information sharing system 300.

The storage 109 may non-temporarily store received cyber incident information 109b and one or more programs 109a. In FIG. 3, the cyber incident information collecting software 109a is illustrated as an example of the programs 109a.

The storage 109 may include a nonvolatile memory such as a read only memory (ROM), an erasable programmable ROM (EPROM), an electrically erasable programmable ROM (EEPROM) or a flash memory, a hard disk, a removable disk, or any form of computer-readable recording medium well known in the art to which the inventive concept pertains.

The cyber incident information collecting software 109a may recursively collect various cyber incident information related to a cyber incident according to an embodiment.

Specifically, the cyber incident information collecting software 109a may be loaded to the memory 103 and executed by the processors 101. The cyber incident information collecting software 109a may include a first operation of collecting a cyber threat indicator through a first information sharing channel, a second operation of setting the collected cyber threat indicator as reference information and collecting an associated indicator retrieved from a second information sharing channel using the reference information, and a third operation of setting the associated indicator as the reference information and repeating the second operation when it is determined that the associated indicator correspond to the type of the reference information and that there is relevance between the cyber threat indicator and the associated indicator, wherein the second information sharing channel is determined according to the type of the reference information.

Until now, the configuration and operation of the cyber incident information collecting apparatus 100 according to the embodiment have been described with reference to FIGS. 2 and 3. Hereinafter, a method of collecting cyber incident information according to an embodiment will be described in detail with reference to FIGS. 4 through 9

It will hereinafter be assumed that each operation of the method of collecting cyber incident information according to the embodiment is performed by the cyber incident information collecting apparatus 100. It should be noted, however, that for ease of description, the subject of each operation included in the cyber incident information collecting method may be omitted. Each operation of the cyber incident information collecting method may be an operation performed by the cyber incident information collecting apparatus 100 as the cyber incident information collecting software 109a is executed by the processors 101.

FIG. 4A is a flowchart illustrating a method of collecting cyber incident information. However, this is merely an embodiment for achieving the objectives of the inventive concept, and some operations can be added or removed if necessary.

Referring to FIG. 4A, the cyber incident information collecting apparatus 100 collects, in real time or in non-real time, one or more cyber threat indicators used in a cyber incident from a first information sharing channel included in the cyber incident information sharing system 300 (operation S100).

Here, the first information sharing channel may be, but is not limited to, a cyber black box, C-share (a cyber incident information sharing system operated by the Korea Internet & Security Agency), a DNSBL, or a distributing point/a malicious code sharing site such as virusshare.com.

In addition, the cyber threat indicators may include domain information, IP information, and hash information of malicious code used in a cyber attack.

Here, the cyber threat indicators collected by the cyber incident information collecting apparatus 100 may vary according to the type of the first information sharing channel. For example, if the first information sharing channel is a cyber black box located at each institution, the cyber incident information collecting apparatus 100 may collect IP information and hash information of malicious code used in a cyber incident by periodically polling an analysis request directory of the cyber black box.

In another example, if the first information sharing channel is C-share, the cyber incident information collecting apparatus 100 may collect a malicious code distributing point/route, a command & control (C&C) IP, an attack IP and hash information of malicious code used in a cyber incident from C-share.

In another example, if the first information sharing channel is a blacklist channel of a DNSBL, the cyber incident information collecting apparatus 100 may collect blacklist IP information, real-time blacklist (RBL) information and blacklist domain information used in a cyber incident from the blacklist channel of the DNSBL.

In another example, if the first information sharing channel is a malicious code sharing site, the cyber incident information collecting apparatus 100 may collect hash information of a new or variant malicious code from the malicious code sharing site.

According to an embodiment, the cyber incident information collecting apparatus 100 may periodically access a malicious code sharing site to retrieve new and variant malicious code information and hash or original file information of the new and variant malicious code. That is, when periodically accessing the malicious code sharing site to update new information, the cyber incident information collecting apparatus 100 may retrieve new and variant malicious code information by crawling on the web page. For example, the cyber incident information collecting apparatus 100 may periodically access the main page of virusshare.com to check a hash value, and, when a hash value of recently collected malicious code does not match the checked hash value, may collect new and variant malicious code information and original file information from virusshare.com.

After collecting the cyber threat indicators, the cyber incident information collecting apparatus 100 sets each of the cyber threat indicators as reference information and retrieves associated indicators from second information sharing channels (operation S110). In addition, the cyber incident information collecting apparatus 100 collects the retrieved associated indicators (operation S120). Here, the reference information may he information used to retrieve associated indicators from the second information sharing channels as described above, and the type of the reference information may be IP information, domain information, or hash information of malicious code.

At least some of the second information sharing channels may be determined to be different kinds of information sharing channels according to the type of the reference information. That is, the second information sharing channels queried by the cyber incident information collecting apparatus 100 may vary according to the type of the reference information. For example, the second information sharing channels may be determined as shown in Table 1 below. However, the inventive concept is not limited to this example, and other information sharing channels can be added as desired.

TABLE 1

| Type of | |
|---|---|
| cyber incident | |
| information | Second information sharing channel |
| IP information | IP2Location, DNS/pointer (PTR) record |
| Domain | Whois, SLD, TLD, DNS, Google cyber incident history |
| information | |
| Malicious code | Malicious code variant detection system, malicious code |
| information | behavior analysis system |

Referring to Table 1, if a cyber threat indicator collected in operation S100 is IP information such as a blacklist IP or a C&C IP, the cyber incident information collecting apparatus 100 retrieves an associated indicator from each channel such as IP2Location or DNS/PTR record and collects the retrieved associated indicators. Alternatively, if the collected cyber threat indicator is domain information, the cyber incident information collecting apparatus 100 retrieves an associated indicator from each channel such as Whots, SLD, TLD, DNS, or Google cyber incident history and collects the retrieved associated indicators.

Specifically, referring to FIG. 4B, if a cyber threat indicator 410 collected in operation S100 is domain information such as ‘XXX-mal.net,’ the cyber incident information collecting apparatus 100 retrieves corresponding IP information 431 through a DNS 421 which is a second information sharing channel, retrieves owner information 433 of the domain ‘XXX-mal.net’ through Whois 423 which is another second information sharing channel, and retrieves malicious code information 435 distributed by the domain ‘XXX-mal.net’ through a Google cyber incident history 425 which is another second information sharing channel. In addition, the cyber incident information collecting apparatus 100 collects the retrieved information as associated indicators associated with the cyber threat indicator 410.

As for associated indicators retrieved from each information sharing channel, if a second information sharing channel is DNS/PTR record, domain information corresponding to IP information may be retrieved as an associated indicator.

Also, if the second information sharing channel is IP2Location, country code (CC), geographical information (latitude/longitude) and Internet service provider (ISP) information of a corresponding IP may be retrieved.

In addition, if the second information sharing channel is Whois, owner information of a corresponding domain may be retrieved. If the second information sharing channel is an SLD or a TLD, similar domain information based on the SLD or similar domain information based on the TLD may be retrieved.

Also, if the second information sharing channel is a malicious code variant detection system, a malicious code behavior analysis system or a Google cyber incident history, a malicious code distribution history, similar malicious code information, application programming interface (API) call information, arid static/dynamic analysis result information may be retrieved,

Until now, the method of collecting cyber incident information by collecting cyber threat indicators and associated indicators according to the embodiment has been described with reference to FIGS. 4A and 4B. Hereinafter, a method of recursively collecting cyber incident information according to an embodiment will be described.

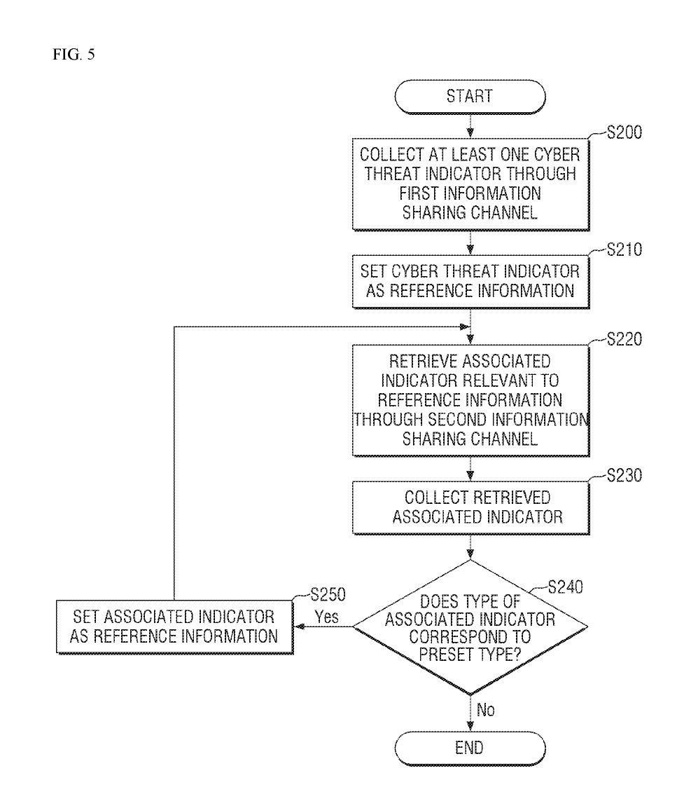

FIG. 5 is a flowchart illustrating a method of recursively collecting cyber incident information.

Referring to FIG. 5, the cyber incident information collecting apparatus 100 collects at least one cyber threat indicator through a first information sharing channel and sets the cyber threat indicator as reference information (operations S200 and S210). In addition, the cyber incident information collecting apparatus 100 queries a second information sharing channel for an associated indicator and collects the retrieved associated indicator (operations S220 and S230). Since operations S200 through S230 are the same as operations S100 through S120 described above, they will not be described here in order to avoid a redundant description.

Next, the cyber incident information collecting apparatus 100 determines whether the type of the collected associated indicator corresponds to a preset type (operation S240). For example, the cyber incident information collecting apparatus 100 determines whether the type of the collected associated indicator corresponds to the type of the reference information that can be used to query the second information sharing channel, such as IP information, domain information, or malicious code information.

If the collected associated indicator corresponds to the preset type, the cyber incident information collecting apparatus 100 sets the collected associated indicator as the reference information and further collects associated indicators by performing operations S220 and S230 again (operations S240 and S250). In addition, operations S220 through S250 may be repeatedly performed until sufficient associated indicators are collected.

For a better understanding, the process of recursively collecting cyber incident information will now be described with reference to FIG. 6.

Referring to FIG. 6, the cyber incident information collecting apparatus 100 collects domain information ‘XXX-mal.net’ used in a cyber incident from a first information sharing channel as a cyber threat indicator 441 and collects associated indicators 443 by querying each second information sharing channel using the domain information ‘XXX-mal.net’ as reference information. Here, an associated indicator ‘IP’ may indicate an IP corresponding to the domain ‘XXX-mal.net,’ an associated indicator ‘owner E-mail’ may indicate the e-mail of the owner of the domain ‘XXX-mal.net’, and an associated indicator ‘malicious code A’ may indicate malicious code distributed in the domain ‘XXX-mal.net.’

In addition, of the associated indicators 443, the cyber incident information collecting apparatus 100 may set an associated indicator (IP or malicious code A) corresponding to IP information, domain information or malicious code information as the reference information and query second information sharing channels again using the reference information. Specifically, the cyber incident information collecting apparatus 100 may query second information sharing channels using the associated indicator ‘malicious code A’ as the reference information and further collect retrieved associated indicators 445. In addition, the cyber incident information collecting apparatus 100 may further collect associated indicators 447 by querying second information sharing channels again for an associated indicator ‘distributing point IP’ which corresponds to the IP information among the associated indicators 445.

For reference, the cyber incident information collecting apparatus 100 may generate and provide the result of recursive collection in the form of an association graph as illustrated in FIG. 6. That is, the cyber incident information collecting apparatus 100 may further perform an operation of generating an association graph showing the associations between a collected cyber threat indicator and collected associated indicators after performing operations S200 through S250. For example, the cyber incident information collecting apparatus 100 may provide the collection result in the form of a hierarchical association graph as illustrated in FIG. 6 by creating nodes indicating a collected cyber threat indicator and collected associated indicators and creating edges indicating the associations resulting from recursive collection.

Until now, the method of recursively collecting cyber incident information according to the embodiment has been described with reference to FIGS. 5 and 6. According to the above-described method, various cyber incident information can be abundantly collected by collecting a cyber threat indicator included in cyber incident information and recursively collecting associated indicators. Accordingly, it is possible to provide base information used to analyze cyber incident information from various angles. Also, it is possible to build a data warehouse that can be used to analyze future cyber incidents by continuously accumulating collected cyber incident information.

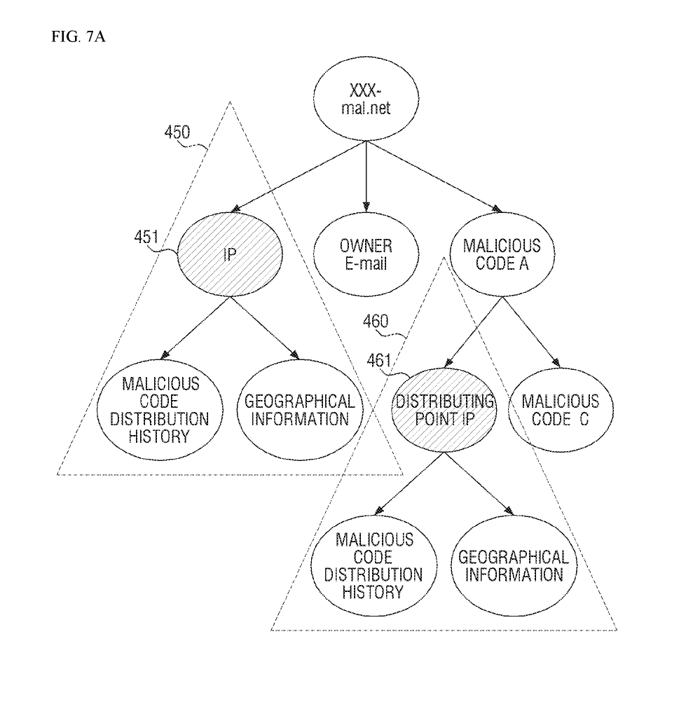

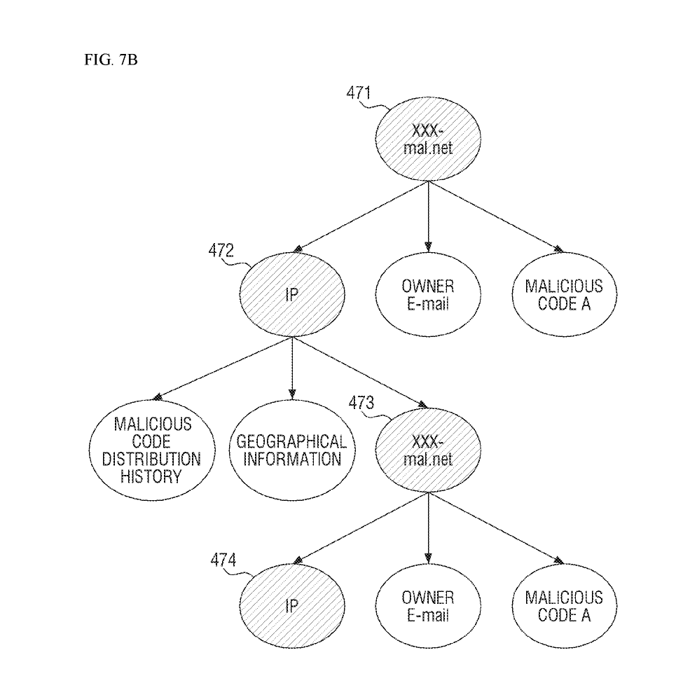

Various embodiments for more efficiently performing the method of recursively collecting cyber incident information will now be described with reference to FIGS. 7A through 11.

As described above, the cyber incident information collecting apparatus 100 according to the inventive concept can recursively collect associated indicators in order to collect various cyber incident information. However, recursively collecting associated indicators can cause the same associated indicator to be collected again or cause an infinite loop problem in which recursive collection is not terminated.

For example, referring to FIG. 7A, if IP information indicated by an associated indicator 451 and IP information indicated by an associated indicator 461 are the same IP, the same associated indicators 450 and 460 may be collected for the associated indicators 451 and 461 because second information sharing channels are queried using the same IP information as reference information.

In addition, referring to FIG. 7B, IP information 472 corresponding to a cyber threat indicator 471 may be collected as an associated indicator through a second information sharing channel DNS), and domain information 473 corresponding to the IP information 472 may be collected as an associated indicator through another second information sharing channel (e.g., DNS/PTR record). In this case, the domain information 471 and 473 and the IP information 472 and 474 may be repeatedly collected in an infinite loop. Therefore, the recursive collection may not be terminated.

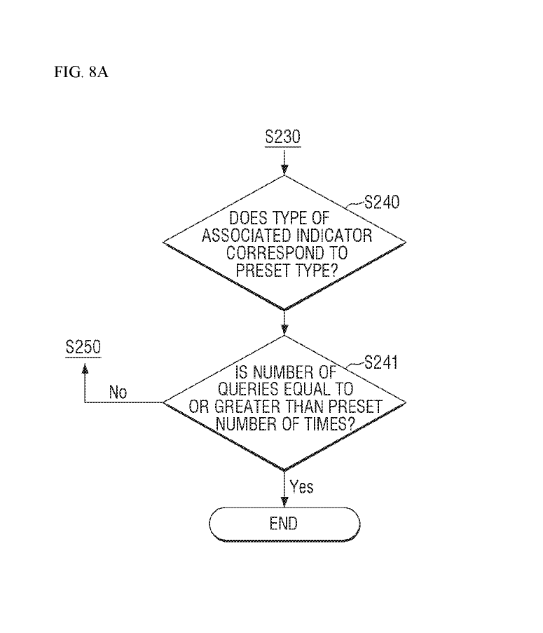

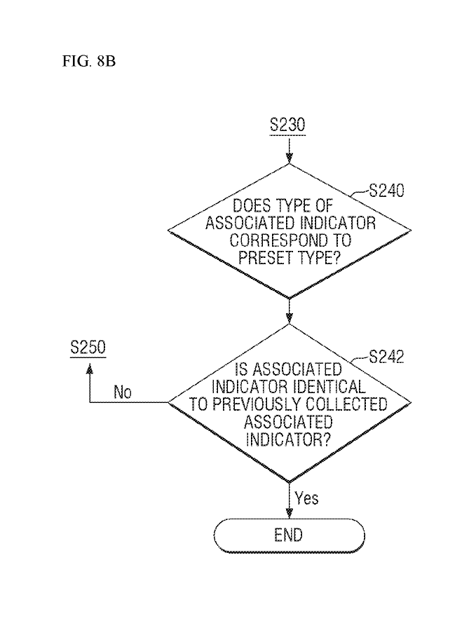

To solve the above problems, the cyber incident information collecting apparatus 100 may limit the number of queries performed on second information sharing channels in recursive collection as illustrated in FIG. 8A. That is, if the number of queries performed on the second information sharing channels exceeds a preset number of times, the recursive collection may be terminated. If the number of queries performed is equal to or less than the preset number of times, the recursive collection may continue (operation S241). For reference, the number of queries performed on the second information sharing channels may be understood to have the same meaning as the number of times that the recursive collection is repeated.

In addition, if the same associated indicator as a previously collected associated indicator is collected, the recursive collection for the associated indicator may be terminated (operation S242) as illustrated in FIG. 8B. Operations S241 and S242 can be combined in any order to solve the redundant collection problem and the infinite loop problem, and operation S240 and operations S241 and S242 can be performed in a reverse order.

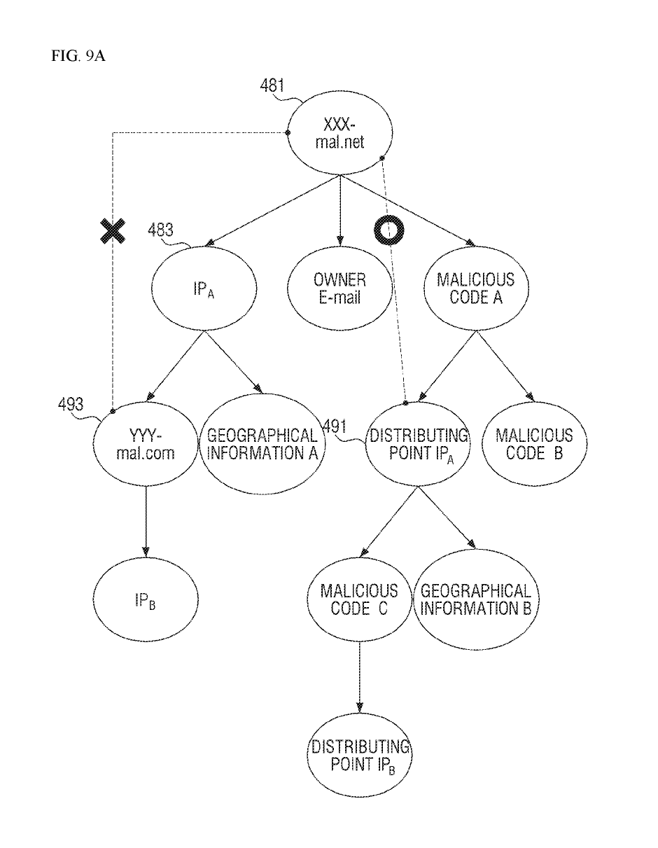

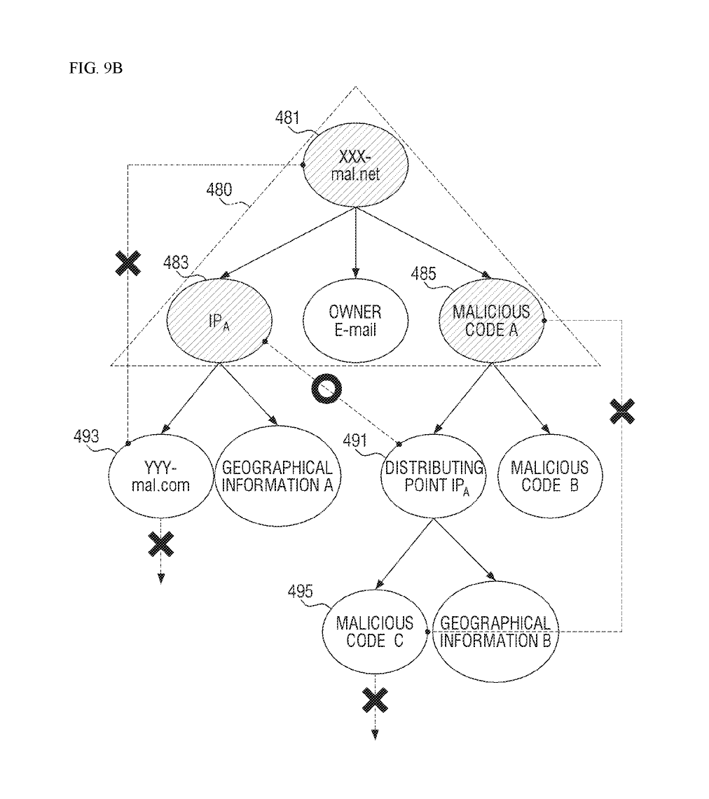

Another problem of the method of recursively collecting cyber incident information is that an associated indicator with low relevance to a cyber threat indicator can be collected. For example, referring to FIG. 9A, although a domain ‘XXX-mal.net’ of a cyber threat indicator 481 and a domain ‘YYY-mal.com’ of an associated indicator 493 are unrelated to each other, the domain ‘YYY-mal.com’ of the associated indicator 493 can be collected as the method of collecting cyber incident information according to the inventive concept is performed recursively. For reference, in the following drawings, a dotted line between two nodes and a mark (‘o’ or ‘x’) superimposed on the dotted line indicate whether there is relevance between pieces of information indicated by the two nodes.

If an associated indicator with low relevance to a cyber threat indicator is collected and used for later analysis, the accuracy of cyber incident analysis can be reduced, or cyber incidents unrelated to each other can be judged as related cyber incidents. Therefore, it may be important to filter out low-relevance cyber incident information in the collecting process.

Generally, the relevance between a cyber threat indicator and an associated indicator may be gradually reduced as the recursive collection is repeated. That is, in an association graph illustrated in FIG. 9A, the relevance to a cyber threat indicator existing in an upper layer may be reduced toward a lower layer. By using such a feature, it is possible to prevent low-relevance associated indicators from being collected by simply limiting the number of queries performed on second information sharing channels as illustrated in FIG. 8A. However, if the number of queries performed is set to an excessively small value, associated indicators may not he sufficiently collected. On the other hand, if the number of queries performed is set to an excessively large value, associated indicators having low relevance may be collected. In addition, since the number of queries in which low-relevance associated indicators are collected can vary according to each piece of cyber incident information, a method of limiting the number of queries to a fixed value may not usually be effective.

Therefore, according to an embodiment, the cyber incident information collecting apparatus 100 may determine whether to perform recursive collection by judging the relevance between a cyber threat indicator and a collected associated indicator. That is, in consideration of the fact that recursive collection is performed only when a collected associated indicator corresponds to the IP information, the domain information or the malicious code information, if a collected associated indicator corresponds to the above type (IP, domain, or malicious code), the cyber incident information collecting apparatus 100 may determine whether to perform recursive collection by judging the relevance between the collected associated indicator and a cyber threat indicator of the same type as that of the collected associated indicator.

For example, when the cyber threat indicator 481 is domain information (XXX-mal.net) and the collected associated indicator 493 is also domain information (YYY-mal.com), the cyber incident information collecting apparatus 100 may determine whether the two domains are related to each other by judging whether the two domains are similar domains based on the TLD, similar domains based on the SLD, and/or have similarity in their strings indicating domain names. Here, the similarity between the strings may be determined using one or more algorithms well known in the art, such as Levenshtein distance and Hamming distance. Since the Levenshtein distance and the Hamming distance are already well known in the art, a description of the Levenshtein distance and the Hamming distance will be omitted.

More specifically, for example, the cyber incident information collecting apparatus 100 may continue the recursive collection for the associated indicator only when the two domains are similar domains based on the TLD and the SLD and when the Levenshtein distance or the Hamming distance is equal to or less than a preset threshold value. That is, in the case of FIG. 9B, since the cyber threat indicator 481 and the associated indicator 493 are different domains based on the TLD, the cyber incident information collecting apparatus 100 may terminate the recursive collection for the associated indicator 493.

However, depending on an implementation method, the cyber incident information collecting apparatus 100 can continue the recursive collection if the Levenshtein distance or the Hamming distance is equal to or less than the preset threshold value even though the two domains are not similar domains based on the TLD and the SLD. It should be noted that this is only a difference in the implementation method.

In another example, when a collected associated indicator 491 is IP information, the cyber incident information collecting apparatus 100 may determine whether to perform the recursive collection by judging the relevance between an IP-type associated indicator 483 located closest to the cyber threat indicator 481 and the associated indicator 491. Alternatively, if there is a collected IP-type cyber threat indicator, the relevance between the IP-type cyber threat indicator and the associated indicator 491 may be judged.

Specifically, the cyber-incident information collecting apparatus 100 may judge the relevance of the two pieces of IP information based on Whether the two pieces of IP information correspond to the same IP class and/or are included in the same network. For example, when the two pieces of IP information 483 and 491 belong to the same IP class, the cyber incident information collecting apparatus 100 may determine that the two pieces of IP information 483 and 491 are related to each other and may continue the recursive collection.

Alternatively, the cyber incident information collecting apparatus 100 may determine whether to perform the recursive collection by converting IP information into domain information and then judging the relevance between domains as described above.

In another example, if a collected associated indicator 495 is malicious code information, the cyber incident information collecting apparatus 100 may determine whether to perform the recursive collection by judging the relevance between an associated indicator 485 of a malicious code type located closest to the cyber threat indicator 481 and the associated indicator 495.

Specifically, the cyber incident information collecting apparatus 100 may judge whether the two malicious codes are related to each other based on the result of a static and/or dynamic analysis of the two malicious codes. For example, the cyber incident information collecting apparatus 100 may judge that the two malicious codes are related to each other when a plurality of identical signatures are found as a result of the static analysis of the two malicious codes or when the behaviors of the two malicious codes are found to be similar as a result of a behavior analysis of the two malicious codes.

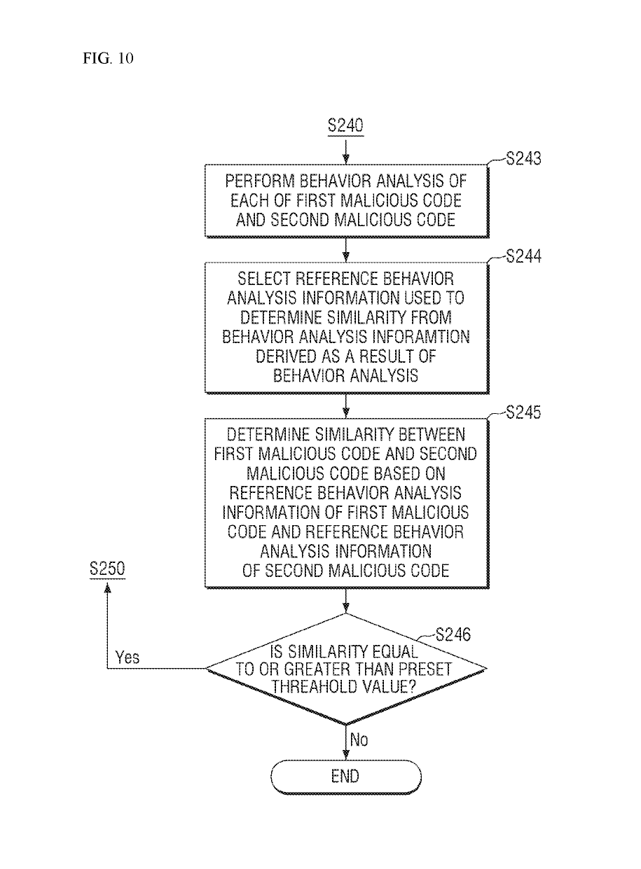

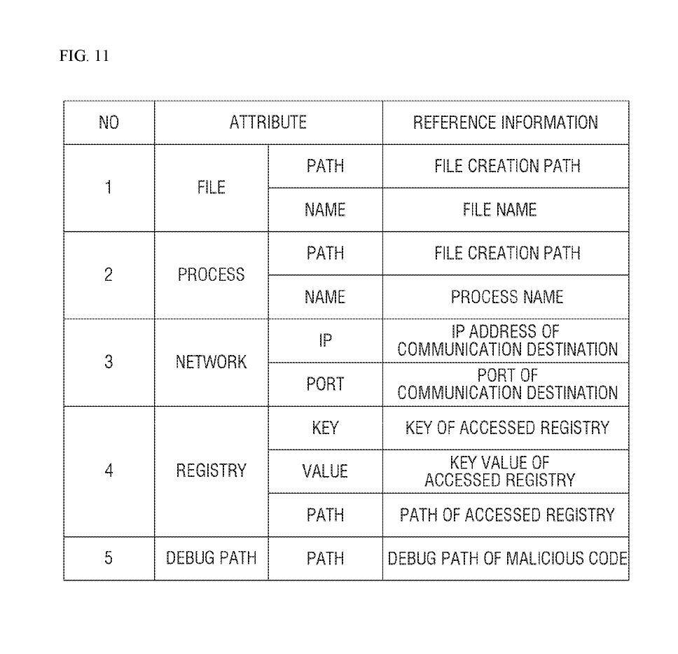

A method of determining whether to perform recursive collection in a case where an associated indicator is malicious code information will now be described in more detail with reference to FIGS. 10 and 11.

FIG. 10 is a flowchart illustrating a method of determining whether to perform recursive collection when an associated indicator is malicious code information.

Referring to FIG. 10, when an associated indicator is malicious code information, it may be judged whether there is relevance between the associated indicator and a cyber threat indicator of a malicious code information type or an associated indicator of the malicious code information type located closest to a cyber threat indicator in an association graph. For example, in the association graph of FIG. 9B, since a cyber threat indicator 481 is not of the malicious code type, it may be judged whether there is relevance between an associated indicator 495 and an associated indicator 485 of the malicious code information type located closest to the cyber threat indicator 481. In addition, two pieces of malicious code information may be determined to be relevant to each other, for example, when the similarity between the two pieces of malicious code information is equal to or greater than a preset threshold value. For ease of description, it will hereinafter be assumed that both an associated indicator and a cyber threat indicator are of the malicious code type.

First, a behavior analysis is performed on malicious code (hereinafter, referred to as ‘first malicious code’) indicated by a cyber threat indicator and malicious code (hereinafter, referred to as ‘second malicious code’) indicated by an associated indicator (operation S243). For example, each of the first malicious code and the second malicious code may be executed on an emulator or a sandbox, and the behavior of each of the first malicious code and the second malicious code may be monitored and analyzed using a method such as API hooking. However, the behavior analysis can also be performed using at least one behavior analysis technique well known in the art.

Next, reference behavior analysis information used to determine the similarity between the first malicious code and the second malicious code is selected from behavior analysis information derived as a result of the behavior analysis (operation S244). For example, the behavior analysis may produce various behavior analysis information such as the API call tree of malicious code, the name and path of a file containing malicious code, the path of a registry accessed by malicious code, the debug path of a malicious code production tool, the path and name of a process created according to the execution of malicious code, and the IP and port of a destination (e.g., C&C server) communicating with malicious code. Here, the reference behavior analysis information used to determine the similarity may be, for example, at least one piece of behavior analysis information illustrated in FIG. 11. However, the inventive concept is not limited to this example, and the reference behavior analysis information can be changed according to the method of determining the similarity between malicious codes.

Next, the similarity between the first malicious code and the second malicious code is determined based on the reference behavior analysis information (hereinafter, referred to as ‘first reference behavior analysis information’) of the first malicious code and the reference behavior analysis information (hereinafter, referred to as ‘second reference behavior analysis information’) of the second malicious code (operation S245). If the similarity is equal to or greater than a preset threshold value, the associated indicator indicating the second malicious code may be set as reference information, and recursive collection may be continuously performed (operations S246 and S250). Here, the similarity may denote, for example, a numerical value indicating the degree of similarity between malicious codes.

Operation S245 in which the similarity between the first malicious code and the second malicious code is determined using the first reference behavior analysis information and the second reference behavior analysis information will now be described in more detail.

For example, when the reference behavior analysis information is a path string indicating any one of the creation path of a file containing malicious code, the creation path of a process executing malicious code, the path of a registry accessed by malicious code and the debug path of malicious code, the similarity between the first malicious code and the second malicious code may be determined based on the similarity between their strings.

More specifically, a path string indicated by each of the first reference behavior analysis information and the second reference behavior analysis information is split into an upper path substring indicating an upper directory and a lower path substring indicating a lower directory under the upper directory by a preset delimiter. Here, the preset delimiter may denote, but not limited to, a directory delimiter such as ‘\.’ In addition, while the path string is described as being split into the upper path substring and the lower path substring for ease of understanding, it can also be split into a plurality of substrings depending on the implementation method. For example, if the path string is ‘C:\Documents and Settings\USER\Local Settings\Temp\,’ it can be split into substrings such as ‘Documents and Settings,’ ‘USER,’ ‘Local Settings,’ and ‘Temp.’

When the path string is split into the upper and lower path substrings, first similarity between the upper path substring included in the first reference behavior analysis information and the upper path substring included in the second reference behavior analysis information is calculated, and second similarity between the lower path substring included in the first reference behavior analysis information and the lower path substring included in the second reference behavior analysis information is calculated. The first and second similarities may be calculated using a string similarity determination algorithm that is widely used in the art, such as the Levenshtein distance or the Hamming distance. For example, the greater the Levenshtein distance, the smaller the first and second similarities. When a path string is split into a plurality of path substrings, the similarity between corresponding pair of the path substrings may be calculated in the same way as described above.

When the first similarity between the upper path substrings and the second similarity between the lower path substrings are calculated, a representative value such as an arithmetic mean or a weighted average of the first similarity and the second similarity may be calculated, and the similarity between the first malicious code and the second malicious code may be determined using the representative value. Here, if the representative value is calculated as the weighted average, a weight given to the first similarity may be set to a value larger than that of a weight given to the second similarity. That is, in view of the hierarchical structure of directories, it can be determined that the entire paths are more similar as the upper directories are similar. However, this can be set differently depending on the implementation method.

In another example, when the reference behavior analysis information is a name string indicating any one of the name of a file containing malicious code and the name of a process executing the malicious code, the similarity between the first malicious code and the second malicious code may be determined based on the similarity between their strings as described above. That is, the similarity may be determined in the same way as described above using the value of the Levenshtein distance or the Hamming distance.

In another example, when the reference behavior analysis information is an IP of a destination communicating with malicious code, if an IP indicated by the first reference behavior analysis information and an IP indicated by the second reference behavior analysis information belong to the same IP class (e.g., C class) or the same IP band, it can be determined that the first malicious code and the second malicious code are similar. Also, a higher similarity value may be determined as the IP addresses match more in each part or as the difference between the values of the IP addresses is smaller. In addition, when the reference behavior analysis information is a port of the destination communicating with the malicious code, a higher similarity value may be determined if a port indicated by the first reference behavior analysis information and a port indicated by the second reference behavior analysis information are the same or if the difference between port numbers is smaller.

Until now, it has been assumed, for ease of understanding, that each of the first reference behavior analysis information and the second reference behavior analysis information includes only one attribute information. However, each of the first reference behavior analysis information and the second reference behavior analysis information can also include a plurality of pieces of attribute information. For example, each of the first reference behavior analysis information and the second reference behavior analysis information may include a plurality of pieces of attribute information among the attribute information illustrated in FIG. 11.

In this case, a similarity value may be determined for each piece of attribute information, and the similarity between the first malicious code and the second malicious code may be determined using a representative value such as an arithmetic mean or a weighted average of the similarity values. More specifically, based on the assumption that each of the first reference behavior analysis information and the second reference behavior analysis information includes first attribute information and second attribute information, first similarity between the first attribute information included in the first reference behavior analysis information and the first attribute information included in the second reference behavior analysis information may be determined, and second similarity between the second attribute information included in the first reference behavior analysis information and the second attribute information included in the second reference behavior analysis information may be determined. Then, a representative value may be calculated as a weighted average or an arithmetic average of the first similarity and the second similarity, and the overall similarity may be determined using the representative value. Here, the first similarity and the second similarity may be determined according to the type of the attribute information by using the above-described similarity determination method.

Furthermore, according to an embodiment, a similarity value calculated using ‘ssdeep’ may be further utilized. Here, the ssdeep is a program for measuring file similarity using a fuzzy hash. Since the ssdeep is a program widely known in the art, a description of the ssdeep will be omitted. According to an embodiment, the ssdeep may be used as an auxiliary index since the accuracy of the ssdeep can be reduced if the file size is 1 MB or less or if the entire binary is changed according to the file format even if the file includes the same information. For example, when the similarity between the first malicious code and the second malicious code is determined using the weighted average of a similarity value calculated through the ssdeep and a similarity value calculated for each attribute, a smaller weight may be given to the similarity value calculated through the ssdeep. Alternatively, if the similarity value calculated through the ssdeep is equal to or greater than a preset threshold value, it may be excluded from the weighted average.

Until now, various methods for more efficiently performing the method of collecting cyber incident information according to the inventive concept have been described with reference to FIGS. 7A through 11. According to the above-described methods, it is possible to prevent the redundant collection problem and the infinite loop problem by limiting the number of queries performed in recursive collection. In addition, whether to perform recursive collection is determined by judging the relevance between a cyber threat indicator and an associated indicator. Therefore, only highly relevant cyber incident information can be collected.

The inventive concept described above with reference to FIGS. 1 through 11 can be embodied as computer-readable code on a computer-readable medium. The computer-readable medium may be, for example, a movable recording medium (CD, DVD, blu-ray disc, USB storage device, or movable hard disc) or a fixed recording medium (ROM, RAM, or computer-embedded hard disc). The computer program recorded on the computer-readable recording medium may be transmitted from a first computing device to a second computing device through a network, such as the Internet, to be installed in the second computing device and thus can be used in the second computing device.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various components in the embodiments described above should not be understood as requiring such separation in all embodiments, and it should be understood that the described program components and systems can generally be integrated together in a single software product or packaged into multiple software products.

According to the inventive concept, it is possible to provide various base information necessary for cyber incident analysis by recursively collecting a cyber threat indicator used in a specific cyber incident and associated indicators relevant to the cyber threat indicator.

In addition, it is possible to establish a data warehouse that systematically manages and provides cyber incident information by continuously accumulating and managing collected cyber incident information.

It is also possible to collect only core cyber incident information highly relevant to a cyber incident by using the relevance between a cyber threat indicator and an associated indicator as a repetition condition for recursive collection.

However, the effects of the inventive concept are not restricted to the one set forth herein. The above and other effects of the inventive concept will become more apparent to one of daily skill in the art to which the inventive concept pertains by referencing the claims.

While the inventive concept has been particularly illustrated and described with reference to exemplary embodiments thereof, it will be understood by those of ordinary skill in the art that various changes in form and detail may be made therein without departing from the spirit and scope of the inventive concept as defined by the following claims. The exemplary embodiments should be considered in a descriptive sense only and not for purposes of limitation.

What is claimed is:

1. A method of collecting cyber incident information, the method being performed by an apparatus for collecting cyber incident information and comprising:
a first operation of collecting a cyber threat indicator through a first information sharing channel;
a second operation of setting the collected cyber threat indicator as reference information and collecting an associated indicator retrieved from a second information sharing channel using the reference information, and
a third operation of setting the associated indicator as the reference information and repeating the second operation when it is determined that the associated indicator corresponds to the type of the reference information and that there is relevance between the cyber threat indicator and the associated indicator,
wherein the second information sharing channel is determined according to the type of e reference information.

2. The method of claim 1, wherein the reference information is one of Internet protocol (IP) information, domain information, and malicious code information.

3. The method of claim 2, wherein when the reference information is the IP information, the second information sharing channel is determined to be at least one of IP2Location and a domain name server (DNS)/pointer (PTR) record.

4. The method of claim 2, wherein when the reference information is the domain information, the second information sharing channel is determined to be at least one of Whois, a top-level domain (TLD), and a second-level domain (SLD).

5. The method of claim 1, wherein the third operation of repeating the second operation comprises repeating the second operation only when the number of times that the second operation is performed is equal to or less than a preset number of times.

6. The method of claim 1, wherein the third operation of repeating the second operation comprises repeating the second operation only when the associated indicator does not match a previously collected associated indicator.

7. The method of claim 1, wherein it is determined that there is relevance between the cyber threat indicator and the associated indicator when both the type of the cyber threat indicator and the type of the associated indicator are the domain information, when a TLD and an SLD of the cyber threat indicator are the same as a TLD and an SLD of the associated indicator, and when a first string indicating a domain name of the cyber threat indicator is similar to a second string indicating a domain name of the associated indicator.

8. The method of claim 7, wherein the first string indicating the domain name of the cyber threat indicator is similar to the second string indicating the domain name of the associated indicator when a Levenshtein distance between the first string and the second string is equal to or less than a preset threshold value.

9. The method of claim 1, wherein it is determined that there is relevance between the cyber threat indicator and the associated indicator when the cyber threat indicator and the associated indicator are the IP information and belong to the same IP class.

10. The method of claim 1, wherein both the type of the cyber threat indicator and the type of the associated indicator are the malicious code information, and the third operation of repeating the second operation comprises:
performing a behavior analysis of each of first malicious code indicated by the cyber threat indicator and second malicious code indicated by the associated indicator;
selecting reference behavior analysis information used to determine the similarity between the first malicious code and the second malicious code from behavior analysis information derived as a result of the behavior analysis;
determining the similarity between the first malicious code and the second malicious code based on first reference behavior analysis information of the first malicious code and second reference behavior analysis information of the second malicious code; and
setting the associated indicator indicating the second malicious code as the reference information and repeating the second operation if the similarity is equal to or greater than a preset threshold value.

11. The method of claim 10, wherein the reference behavior analysis information comprises a creation path of a file containing malicious code, a creation path of a process executing malicious code, an IP address of a destination communicating with malicious code, a path of a registry accessed by malicious code, and a debug path of malicious code.

12. The method of claim 10, wherein each of the first reference behavior analysis information and the second reference behavior analysis information is a path string indicating any one of a creation path of a file containing malicious code, a creation path of a process executing malicious code, a path of a registry accessed by malicious code and a debug path of malicious code, and the determining of the similarity between the first malicious code and the second malicious code comprises:
splitting a path string indicated by each of the first reference behavior analysis information and the second reference behavior analysis information into an upper path substring indicating an upper directory and a lower path substring indicating a lower directory using a preset delimiter;
calculating first similarity between a first upper path substring included in the first reference behavior analysis information and a second upper path substring included in the second reference behavior analysis information using the Levenshtein distance between the first upper path substring and the second upper path substring;
calculating second similarity between a first lower path substring included in the first reference behavior analysis information and a second lower path substring included in the second reference behavior analysis information using the Levenshtein distance between the first lower path substring and the second lower path substring; and
calculating a weighted average of the first similarity and the second similarity and determining the similarity between the first malicious code and the second malicious code using the weighted average,
wherein a weight given to the first similarity to calculate the weighted average is set to a larger value than that of a weight given to the second similarity.

13. The method of claim 10, wherein each of the first reference behavior analysis information and the second reference behavior analysis information comprises first attribute information and second attribute information, and the determining of the similarity between the first malicious code and the second malicious code comprises:
determining first similarity between the first attribute information included in the first reference behavior analysis information and the first attribute information included in the second reference behavior analysis information;
determining second similarity between the second attribute information included in the first reference behavior analysis information and the second attribute information included in the second reference behavior analysis information; and
calculating a weighted average of the first similarity and the second similarity and determining the similarity between the first malicious code and the second malicious code using the weighted average.

14. An apparatus for collecting cyber incident information, the apparatus comprising:
one or more processors;
a network interface which receives cyber incident information from at least one information sharing channel;
a memory which loads a computer program to be executed by the processors; and
a storage which stores the computer program and the received cyber incident information,
wherein the computer program comprises:
a first operation of collecting a cyber threat indicator through a first information sharing channel;
a second operation of setting the collected cyber threat indicator as reference information and collecting an associated indicator retrieved from a second information sharing channel using the reference information, and
a third operation of setting the associated indicator as the reference information and repeating the second operation when it is determined that the associated indicator corresponds to the type of the reference information and that there is relevance between the cyber threat indicator and the associated indicator,
wherein the second information sharing channel is determined according to the type of the reference information.

15. A computer program coupled to a computing device and stored in a recording medium to execute:
a first operation of collecting a cyber threat indicator through a first information sharing channel;
a second operation of setting the collected cyber threat indicator as reference information and collecting an associated indicator retrieved from a second information sharing channel using the reference information, and
a third operation of setting the associated indicator as the reference information and repeating the second operation when it is determined that the associated indicator corresponds to the type of the reference information and that there is relevance between the cyber threat indicator and the associated indicator,
wherein the second information sharing channel is determined according to the type of the reference information.
